(19) United States
(12) Patent Application Publication
(10) Pub. No.: US 2016/0163433 A1
(43) Pub. Date: Jun. 9, 2016

(54) Chip-Resistor Manufacturing Method

(71) Applicant: KOA CORPORATION, Nagano (JP)

(72) Inventors: Yuya TAKEUE, na-shi (JP); Todaro UEGANE, Ina-shi (JP); Kentaro MATSUMOTO, Ina-shi (JP)

(21) Appl. No.: 14/905,459

(22) PCT Filed: Jul. 9, 2014
(86) PCT No.: PCT/JP2014/068350

§ 371 Date: Jan. 15, 2016

(30) Foreign Application Priority Data
Jul. 17, 2013 (JP) 2013-148791

(51) Int. Cl. H01C 17/28; H01C 17/22; H01C 17/06

(52) U.S. Cl. CPC H01C 17/28; H01C 17/06; H01C 17/22

(57) ABSTRACT

The invention is to provide a chip-resistor manufacturing method in which chipping can be restrained from occurring in an intersection portion between each primary segmentation groove and each secondary segmentation groove. Primary segmentation grooves 21 each having an uneven depth are formed in one surface of a large substrate 20. Pairs of surface electrodes 3 extending across the primary segmentation grooves 21, resistive elements 5 each striding between the surface electrodes 3 paired with each other, etc. are formed in the one surface of the large substrate 20. Then, primary segmentation is performed on the large substrate 20 along the primary segmentation grooves 21 so as to open the surface side where the surface electrodes 3, the resistive elements 5, etc. are formed. Thus, a plurality of strip-like substrates 30 are obtained from the large substrate 20. During the primary segmentation, each primary segmentation groove 21 begins to break from electrode formation regions which are small in groove depth but strong, and then breaks in intersection portions which are large in groove depth but brittle. Accordingly, it is possible to perform primary segmentation on the primary segmentation groove 21 without applying a large load to the intersection portions which are low in strength. Thus, it is possible to prevent chipping from occurring in the intersection portions.

### TECHNICAL FIELD

The present invention relates to a chip-resistor manufacturing method in which a sheet-like large substrate is segmented along longitudinal and lateral segmentation grooves so that chip-resistors can be obtained.

### BACKGROUND ART

A chip-resistor mainly includes an insulating substrate, a pair of electrode portions, a resistive element, an insulating protective coat, etc. The insulating substrate is shaped like a rectangle in plan view. The pair of electrode portions are provided on the insulating substrate at a predetermined interval from each other. The resistive element bridges the electrode portions paired with each other. The resistive element is covered with the insulating protective coat. A trimming groove used for adjustment of a resistive value is formed in the resistive element. Each of the electrode portions includes a surface electrode, a back electrode, and an end face electrode which bridges the two electrodes. The pair of surface electrodes are bridged by the resistive element on a front surface side of the insulating substrate.

Normally, when such chip-resistors are manufactured, a plurality of primary segmentation grooves and a plurality of secondary segmentation grooves extending longitudinally and laterally are formed in one surface or opposite surfaces of a sheet-like large substrate (aggregate substrate) in advance. After the electrode portions, the resistive elements, the protective coats etc. are formed in a lump on the one surface of the large substrate, the large substrate is broken (for primary segmentation) into strip-like substrates along the primary segmentation grooves. The end face electrodes are formed on the strip-like substrates, and then the strip-like substrates are broken (for secondary segmentation) along the secondary segmentation grooves. In this manner, a large number of individual divided chip-resistors are completed. When the large substrate or the strip-like substrates cannot be broken completely along the segmentation grooves on this occasion, the shape of a segmentation face as each end face of each chip-resistor can be distorted easily. Accordingly, a manufacturing yield of the chip-resistors is lowered.

To solve this problem, according to the background art, there has been proposed a technique as follows. That is, primary segmentation grooves and secondary segmentation grooves are formed in opposite front and back surfaces of a large substrate. In this situation, a groove depth of each primary segmentation groove formed on the front surface side is set to be larger (deeper) than a groove depth of each primary segmentation groove formed on the back surface side and a groove depth of each secondary segmentation groove formed on the front surface side is set to be smaller (shallower) than a groove depth of each secondary segmentation groove formed on the back surface side (e.g. see Patent Literature 1). According to the background-art technique, the primary segmentation grooves which are formed to be deeper on the front surface side are broken in an opening direction during primary segmentation. However, the secondary segmentation grooves formed on the front surface side are shallower. Therefore, it is possible to suppress unintended breaking along the secondary segmentation grooves which have to be concerned in the primary segmentation step. In addition, when the secondary segmentation grooves on the front surface side are broken in an opening direction during secondary segmentation performed subsequently, the secondary segmentation grooves can be broken easily toward the secondary segmentation grooves which are formed to be deeper on the back surface side. Accordingly, it is also possible to prevent shape failure from easily occurring in any end face of each chip-resistor.

### CITATION LIST

### Patent Literature

Patent Literature 1: JP-A-2004-259767

### SUMMARY OF INVENTION

### Technical Problem

In such a chip-resistor manufacturing method, the primary segmentation for breaking the large substrate into strip-like substrates along the primary segmentation grooves has to be performed with a larger force than the secondary segmentation for breaking each of the strip-like substrates into individual divided pieces along the secondary segmentation grooves. Accordingly, chipping occurs easily in an intersection portion between each primary segmentation groove and each secondary segmentation groove during the primary segmentation. That is, the secondary segmentation grooves are formed at fixed intervals to extend across the primary segmentation grooves. Therefore, when the large substrate is broken into the strip-shape substrates along the primary segmentation grooves, intersection portions between the primary segmentation grooves and the secondary segmentation grooves may be more brittle than any other region. Thus, there is a fear that chipping may occur in such an intersection portion during the primary segmentation.

Incidentally, according to the background-art technique disclosed in Patent Literature 1, the groove depth of each primary segmentation groove or each secondary segmentation groove in the front surface is made relatively different from that in the back surface. Thus, shape failure occurring in any end face during the primary segmentation or during the secondary primary segmentation is reduced. However, since the individual primary segmentation groove or the individual secondary segmentation groove is simply formed with an even depth, the intersection portion between the primary segmentation groove and the secondary segmentation groove is more brittle than any other region so that chipping cannot be restrained from occurring in the intersection portion during the primary segmentation.

The invention has been accomplished in consideration of such actual circumstances of the background-art technique. An object of the invention is to provide a chip-resistor manufacturing method in which chipping can be restrained from occurring in an intersection portion between each primary segmentation groove and each secondary segmentation groove.

### Solution to Problem

In order to achieve the aforementioned object, the invention provides a chip-resistor manufacturing method including: a step of forming primary segmentation grooves and secondary segmentation grooves in a sheet-like large substrate to thereby extend the primary segmentation grooves and the secondary segmentation grooves longitudinally and laterally; a step of forming pairs of electrodes in one surface of the large substrate to thereby extend the electrodes across the primary segmentation grooves; a step of forming resistive elements to thereby connect the resistive elements to the pairs of electrodes; a step of forming a protective layer to thereby cover the resistive elements with the protective layer; a step of segmenting the large substrate along the primary segmentation grooves to thereby form strip-like substrates; a step of forming end face electrodes on segmentation faces of the strip-like substrates; and a step of segmenting the strip-like substrates along the secondary segmentation grooves to thereby form individual devices; wherein: of the primary segmentation grooves, regions which include intersection portions with the secondary segmentation grooves and in which the electrodes are not formed are set to be larger in groove depth than regions in which the electrodes are formed, so that the large substrate can be segmented along the primary segmentation grooves to thereby form the strip-like substrates.

According to the chip-resistors manufactured by such steps, after the electrodes, the resistive elements, etc. are formed in the one surface of the large substrate, the large substrate is segmented along the primary segmentation grooves to open the one surface side of the large substrate. In this case, the large substrate first begins to break from the electrode formation regions which are small in groove depth but strong, and then breaks in the intersection portions which are large in groove depth but brittle. Accordingly, it is possible to perform primary segmentation on the large substrate without applying a large load to the intersection portions which are low in strength. Thus, it is possible to prevent chipping from occurring in the intersection portions.

In the aforementioned chip-resistor manufacturing method, it is preferable that the relation D1≦(D2+20 μm) is established between D1 and D2 when the groove depth in the regions where the electrodes are not formed is D1 and the groove depth in the regions where the electrodes are formed is D2.

In addition, in the aforementioned chip-resistor manufacturing method, the primary segmentation grooves whose groove depths differ in accordance with the regions may be formed in the large substrate in advance and the electrodes may be formed to extend across the regions in which the primary segmentation grooves are shallow in groove depth. However, it is preferable that the electrodes are formed with a film thickness of 30 μm to 60 μm on the large substrate having no segmentation grooves, and the large substrate is then irradiated with a laser so that the primary segmentation grooves can be formed in the large substrate to extend across the electrodes. In this case, the primary segmentation grooves having different groove depths can be formed easily.

### Advantageous Effects of Invention

According to the chip-resistor manufacturing method according to the invention, the groove depth of each primary segmentation groove in the electrode formation regions is made different from that in the other regions. After the electrodes, the resistive elements, etc. are formed in the one surface of the large substrate, the large substrate is segmented along the primary segmentation grooves so as to open the one surface side of the large substrate. In this case, the large substrate first begins to break from the electrode formation regions which are small in groove depth but strong, and then breaks in the intersection portions which are large in groove depth but brittle. Accordingly, it is possible to perform primary segmentation on the large substrate without applying a large load to the intersection portions which are low in strength. Thus, it is possible to prevent chipping from occurring in the intersection portions.

### BRIEF DESCRIPTION OF DRAWINGS

FIG. 1 is a plan view showing a chip-resistor according to the invention.

FIG. 2 is a sectional view taken along a line II-II of FIG. 1.

FIGS. 3A-3F are explanatory views showing a method for manufacturing the chip-resistor according to a first embodiment.

FIG. 4 is an enlarged sectional view taken along a line IV-IV of FIG. 3A.

FIGS. 5A-5G are explanatory views showing a method for manufacturing the chip-resistor according to a second embodiment.

FIG. 6 is an enlarged sectional view taken along a line VI-VI of FIG. 5C.

### DESCRIPTION OF EMBODIMENTS

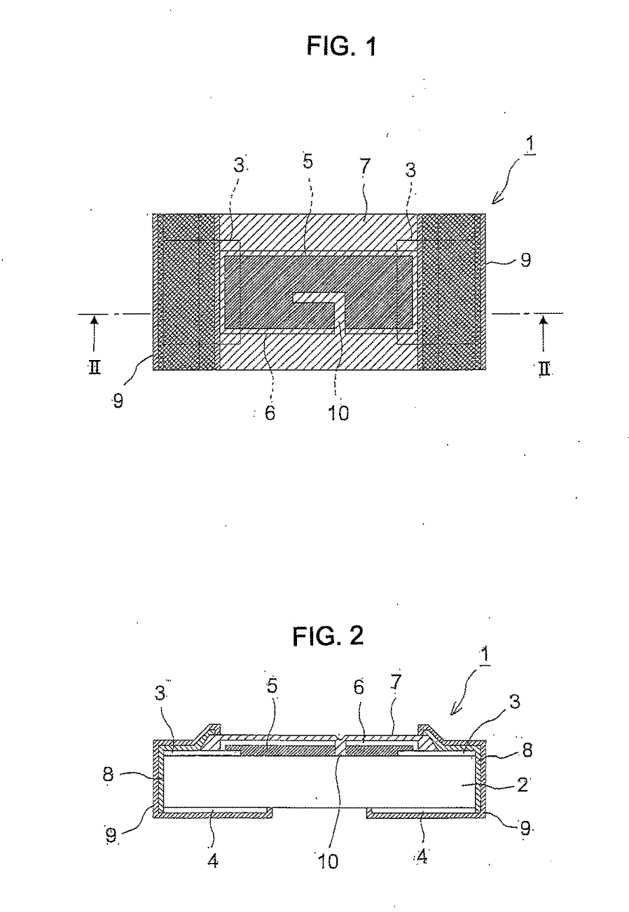

Embodiments of the invention will be described below with reference to the drawings. As shown in FIGS. 1 and 2, a chip-resistor 1 according to the invention mainly includes an insulating substrate 2, a pair of surface electrodes 3, a pair of back electrodes 4, a resistive element 5, an undercoat 6, an overcoat 7, a pair of end face electrodes 8, and a plating layer 9. The insulating substrate 2 is shaped like a rectangular parallelepiped. The pair of surface electrodes 3 are provided on longitudinally opposite end portions of a front surface (upper surface in FIG. 2) of the insulating substrate 2. The pair of back electrodes 4 are provided on longitudinally opposite end portions of a back surface (lower surface in FIG. 2) of the insulating substrate 2. The resistive element 5 is provided on the front surface of the insulating substrate 2 so that opposite end portions of the resistive element 5 can be superimposed on the pair of surface electrodes 3. The resistive element 5 is covered with the undercoat 6. The undercoat 6 is covered with the overcoat 7. The pair of end face electrodes 8 bridge the surface electrodes 3 and the back electrodes 4. Parts of the surface electrodes 3, the back electrodes 4 and the end face electrodes 8 are covered with the plating layer 9.

The insulating substrate 2 is made of ceramic etc. A large substrate which will be described later is segmented along primary and secondary segmentation grooves extending longitudinally and laterally so that a large number of the insulating substrates 2 can be obtained. The surface electrodes 3 are formed by screen-printing, drying and baking Ag paste. Similarly, the back electrodes 4 are also formed by screen-printing, drying and baking Ag paste. The resistive element 5 is formed by screen-printing, drying and baking resistive element paste of ruthenium oxide etc. A trimming groove 10 used for adjustment of a resistive value is formed in the resistive element 5. The undercoat 6 is formed by screen-printing and baking glass paste. The undercoat 6 is formed so that the resistive element 5 can be covered with the undercoat 6 before the trimming groove 10 is formed. The overcoat 7 is formed by screen-printing and thermally curing epoxy-based resin paste. The overcoat 7 is formed after the trimming groove 10 is formed in the resistive element 5.

The end face electrodes 8 are formed by sputtering so that end surfaces of the insulating substrate 2 and the surface electrodes 3 can be covered with the end face electrodes 8. The end face electrodes 8 are made of Nichrome (Ni/Cr) having excellent adhesion properties to the insulating substrate 2. The plating layer 9 is formed by electroplating so that parts of the surface electrodes 3, the back electrodes 4 and the end face electrodes 8 can be covered with the plating layer 9. The plating layer 9 is made of tin (Sn)-lead (Pb), lead-free Sn, etc. together with nickel (Ni) serving as a barrier layer.

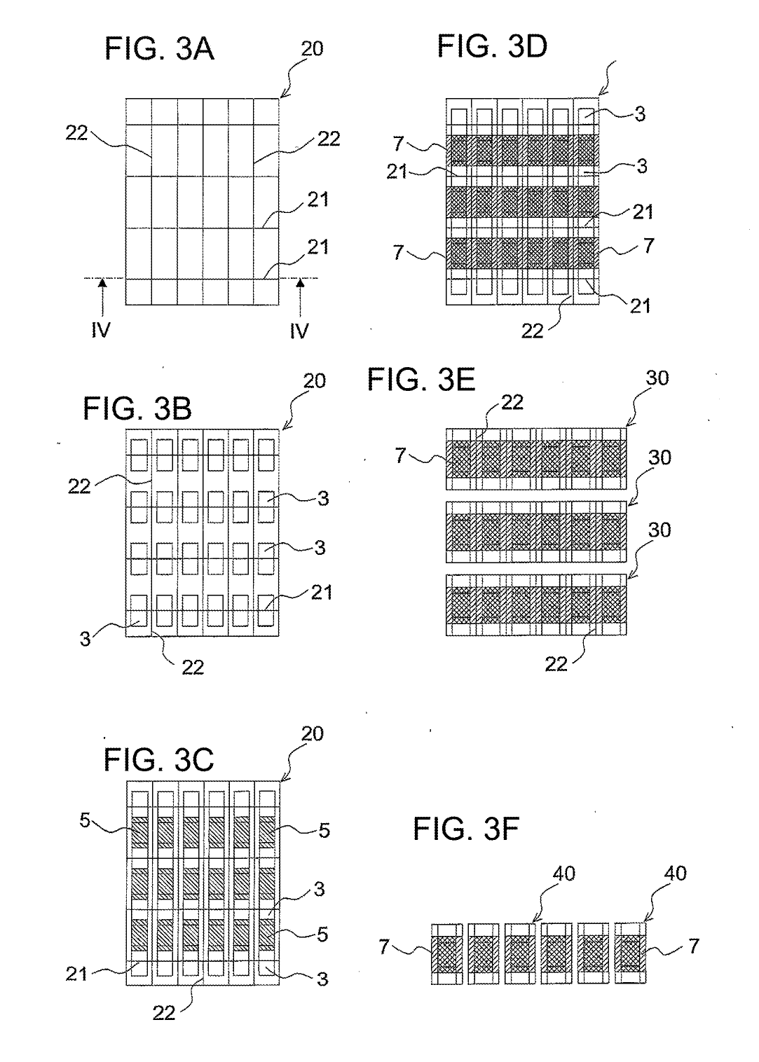

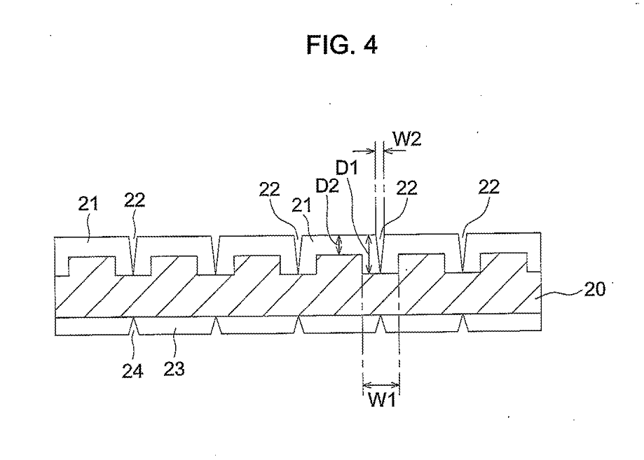

Next, a method for manufacturing the chip-resistor 1 configured as described above according to a first embodiment will be described with reference to FIGS. 3 and 4.

First, as shown in FIG. 3(a), a sheet-like large substrate 20 from which a large number of insulating substrates 2 can be obtained is prepared. The large substrate 20 is, for example, a 0.5 mm-thick ceramic substrate (96% aluminum substrate). Primary segmentation grooves 21 and secondary segmentation grooves 22 are formed in one surface (front surface) of the large substrate 20 and arranged in a lattice form in which the primary segmentation grooves 21 and the secondary segmentation grooves 22 extend longitudinally and laterally. Each of the primary segmentation grooves 21 and the secondary segmentation grooves 22 is a groove having a V-shape in section. Each secondary segmentation groove 22 extends linearly with an even groove depth. Each primary segmentation groove 21 extends linearly with an uneven groove depth in which shallow portions and deep portions are arranged continuously and alternately to each other.

That is, as shown in FIG. 4, a groove depth (=D1) of each primary segmentation groove 21 in an intersection portion with each secondary segmentation groove is larger than a groove depth (=D2) of the primary segmentation groove 21 in each portion which is interposed between adjacent intersection portions. The relation D1≧(D2+20 μm) is established between the groove depths D1 and D2. In addition, a width W1 of the portion with the groove depth D1 is larger than a width W2 of the V-shaped groove which is the secondary segmentation groove 22. The relation W1>W2 is established between the widths W1 and W2. In the case of the embodiment, D1=130 μm to 160 μm and D2=80 μm to 100 μm when the 0.5 mm-thick large substrate 20 is used. Incidentally, primary segmentation grooves 23 and secondary segmentation grooves 24 are also formed in the other surface (back surface) of the large substrate 20 and arranged in a lattice form in which the primary segmentation grooves 23 and the secondary segmentation grooves 24 extend longitudinally and laterally. The groove depths of the primary and secondary segmentation grooves 23 and 24 are shallower than those of the primary and secondary segmentation grooves 21 and 22 on the front surface side. In addition, all the primary and secondary segmentation grooves 23 and 24 are set at an even groove depth (30 μm to 60 μm).

Next, Ag paste is screen-printed and baked so as to extend across the primary segmentation grooves 21. Thus, as shown in FIG. 3(b), pairs of surface electrodes 3 are formed on the front surface of the large substrate 20. The surface electrodes 3 are formed in regions (portions with the groove depth D2 in FIG. 4) in which the primary segmentation grooves 21 are shallow in groove depth. It is preferable that the surface electrodes 3 are not formed in regions (portions with the groove depth D1 in FIG. 4) which include the intersection portions and in which the primary segmentation grooves 21 are deep in groove depth so that adjacent surface electrodes 3 can be prevented from being connected to each other through the segmentation grooves. Incidentally, when the surface electrodes 3 are alternatively formed in the regions in which the primary segmentation grooves 21 are deep in groove depth, the width of each surface electrode 3 and the width W1 of each portion with the groove depth D1 does not have to be consistent with each other but the width of the surface electrode 3 may be set to be slightly narrower than the width W1 of the portion with the groove depth D1. Although not shown, pairs of back electrodes 4 are also formed on the back surface of the large substrate 20 so as to extend across the primary segmentation grooves 23.

Next, ruthenium oxide-based resistive element paste is screen-printed and baked so as to stride between the surface electrodes 3 paired with each other. In this manner, as shown in FIG. 3(c), a plurality of resistive elements 5 are formed in a lump so that longitudinally opposite end portions of the resistive elements 5 can be superimposed on the surface electrodes 3.

Next, glass paste is screen-printed and baked in regions where the respective resistive elements 5 should be covered separately. Thus, undercoats 6 are formed on the resistive elements 5 respectively. Then, the resistive elements 5 covered with the undercoats 6 are irradiated with a laser beam so as to form trimming grooves 10 therein. Then, epoxy-based resin paste is screen-printed and thermally cured in the regions where the undercoats 6 and the resistive elements 5 should be covered. Thus, as shown in FIG. 3(d), overcoats 7 which extend like belts across the secondary segmentation grooves 22 are formed in the regions where the undercoats 6 and the resistive elements 5 should be covered.

The steps performed so far are batch processing performed on the large substrate 20. In the next step, the large substrate 20 is broken (for primary segmentation) into strip-like parts along the primary segmentation grooves 21 and 23 in the front and back surfaces. Thus, as shown in FIG. 3(e), a plurality of strip-like substrates 30 are obtained from the large substrate 20. The primary segmentation work is performed by bending stress which is applied in a direction to extend the front surface side of the large substrate 20. Thus, the primary segmentation grooves 21 are broken by the bending stress so that openings in the grooves on the front surface side can be opened.

Here, the groove depth of each primary segmentation groove 21 formed in the front surface of the large substrate 20 is not even but has regions with a large groove depth and regions with a small groove depth. Therefore, during the primary segmentation, the primary segmentation groove 21 first begins to break from the regions (the portions with the groove depth D2 in FIG. 4) which are small in groove depth but strong, and then breaks in the intersection portions (the portions with the groove depth D1 in FIG. 4) which are large in groove depth but brittle. Accordingly, it is possible to perform primary segmentation on the primary segmentation groove 21 without applying a large load to the intersection portions which are low in strength. Thus, it is possible to prevent chipping from occurring in the intersection portions.

Next, the strip-like substrates 30 are put on top of one another in an up/down direction. Then, Ni/Cr is sputtered all over end faces of the respective strip-like substrates 30 in this state. Thus, end face electrodes 8 which bridge the front electrodes 3 and the back electrodes 4 are formed on the end faces of the strip-like substrates 30. Then, secondary segmentation is performed to break the strip-like substrates 30 along the secondary segmentation grooves 22 and 24. As shown in FIG. 3(f), individual pieces (single chips) 40 each having an equivalent size to the chip-resistor 1 are obtained. Finally, electroplating is applied to an insulating substrate 2 of each individual divided single chip 40. Thus, a plating layer 9 is formed on the insulating substrate 2 so that parts of the front electrodes 3, the back electrodes 4 and the end face electrodes 8 can be covered with the plating layer 9. Thus, the chip-resistor 1 shown in FIGS. 1 and 2 is completed.

As described above, the method for manufacturing the chip-resistor 1 according to the embodiment is performed as follows. That is, the primary segmentation grooves 21 each having an uneven depth are formed in one surface of the large substrate 20 in advance. The pairs of the surface electrodes 3 extending across the primary segmentation grooves 21, the resistive elements 5 each striding between the surface electrodes 3 paired with each other, etc. are formed in the large substrate 20. Then, primary segmentation is performed on the large substrate 20 along the primary segmentation grooves 21 so as to open the surface side where the surface electrodes 3, the resistive elements 5, etc. are formed. Therefore, during the primary segmentation, each primary segmentation groove 21 begins to break from the electrode formation regions which are small in groove depth but strong, and then breaks in the intersection portions which are large in groove depth but brittle. Accordingly, it is possible to perform primary segmentation on the primary segmentation groove 21 without applying a large load to the intersection portions which are low in strength. Thus, it is possible to prevent chipping from occurring in the intersection portions.

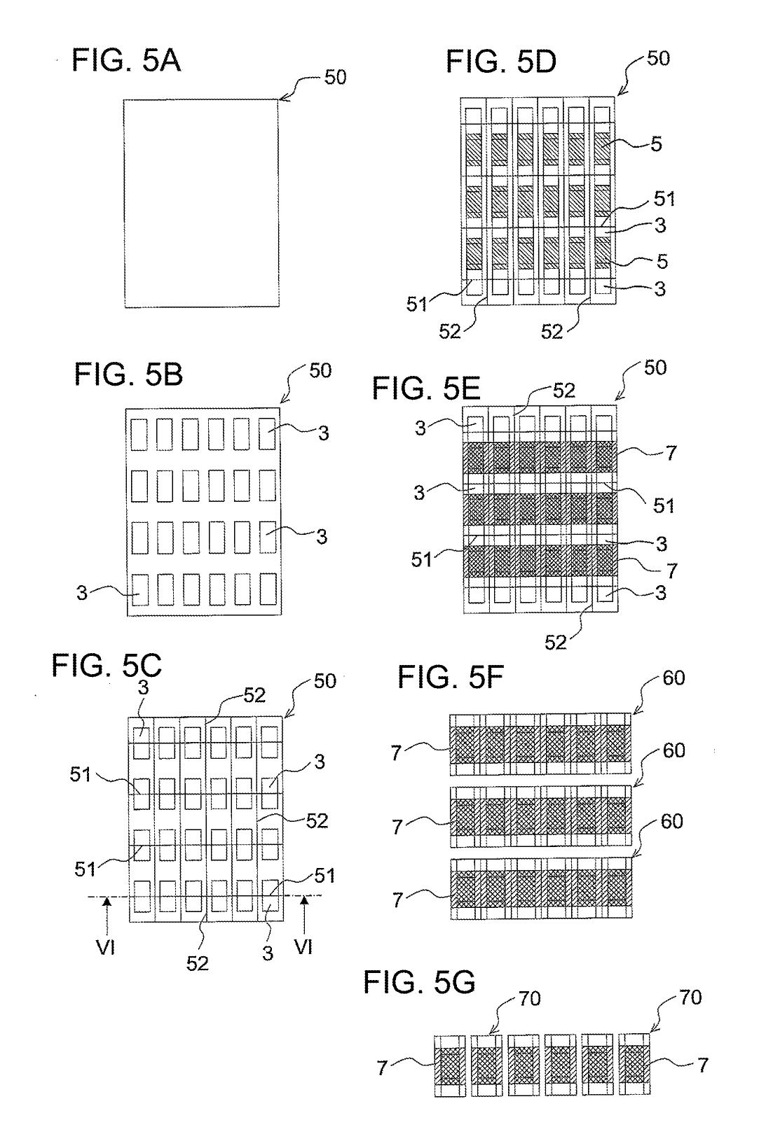

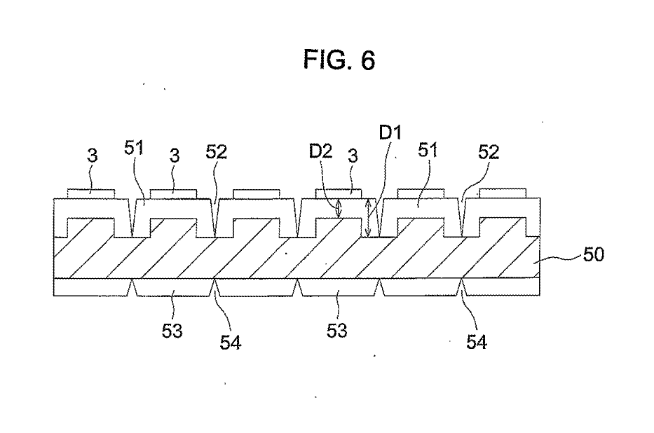

Next, a method for manufacturing the chip-resistor 1 according to a second embodiment will be described with reference to FIGS. 5 and 6.

In the second embodiment, first, as shown in FIG. 5(a), a sheet-like large substrate 50 from which a large number of insulating substrates 2 can be obtained is prepared. The large substrate 50 is, for example, a 0.5 mm-thick ceramic substrate (96% aluminum substrate). At this point of time, primary and secondary segmentation grooves are not formed in the large substrate 50.

Next, when copper (Cu) paste is screen-printed on one surface (front surface) of the large substrate 50 and baked, pairs of front electrodes 3 arranged in a matrix form are formed, as shown in FIG. 5(b). On this occasion, it is preferable that each surface electrode 3 is thick to be about 30 μm to 60 μm in the film thickness. In the case of the embodiment, the surface electrode 3 is set to have a structure of two layers of 20 μm Cu paste. Thus, the surface electrode 3 having a film thickness of 40 μm is formed. Although not shown, the same steps are also performed on the back surface of the large substrate 50. Thus, pairs of back electrodes 4 arranged in a matrix form are formed in the back surface of the large substrate 50. However, the back electrodes 4 do not have to be as thick in film thickness as the surface electrodes 3. In the case of the embodiment, Ag paste is used to form the 10 μm-thick back electrodes 4.

Next, by a laser scribing method for irradiating the large substrate 50 with a laser so as to form segmentation grooves therein, primary segmentation grooves 51 and secondary segmentation grooves 52 are formed in the front surface of the large substrate 50 and arranged in a lattice form in which the primary segmentation grooves 51 and the secondary segmentation grooves 52 extend longitudinally and laterally, as shown in FIG. 5(c). Here, the primary segmentation grooves 51 are formed by laser irradiation so as to extend across the surface electrodes 3. The film thickness of each surface electrode 3 is formed to be thick (40 μm) as described above. Accordingly, each primary segmentation groove 51 is formed with an uneven groove depth in which shallow portions and deep portions are arranged continuously and alternately to each other. That is, as shown in FIG. 6, a groove depth (=D2) of the primary segmentation groove 51 in regions where the surface electrodes 3 are formed is shallower than a groove depth (=D1) of the primary segmentation groove 51 in regions where the surface electrodes 3 are not formed. In the case of the embodiment, D1=140 μm and D2=100 μm. Irregularities of about 40 μm are formed in the groove depth of the primary segmentation groove 51. On the other hand, the secondary segmentation grooves 52 are formed by laser irradiation to extend through portions of the large substrate 50 where the surface electrodes 3 are absent. Accordingly, a groove depth of each secondary segmentation groove 52 is even, and a groove depth of each intersection portion where the primary segmentation groove 51 and the secondary segmentation groove 52 intersect with each other is D1.

In addition, primary segmentation grooves 53 and secondary segmentation grooves 54 are also formed in the other surface (back surface) of the large substrate 50 by the laser scribing method. The groove depths of the primary and secondary segmentation grooves 53 and 54 are shallower than those of the primary and secondary segmentation grooves 51 and 52 on the front surface side, and all the primary and secondary segmentation grooves 53 and 54 are set at an even groove depth (e.g. 40 μm). Incidentally, although the primary and secondary segmentation grooves 51 and 52 on the front surface side have to be formed in the large substrate 50 by laser irradiation after the front electrodes 3 are formed, the primary and secondary segmentation grooves 53 and 54 on the back surface side may be formed in advance in the large substrate 50 before the surface electrodes 3 are formed.

Next, ruthenium oxide-based resistive element paste is screen-printed and baked to stride between the surface electrodes 3 paired with each other. In this manner, as shown in FIG. 5(d), a plurality of resistive elements 5 are formed in a lump so that longitudinally opposite end portions of the resistive elements 5 can be superimposed on the surface electrodes 3.

Next, glass paste is screen-printed and baked in regions in which the respective resistive elements 5 should be covered separately. Thus, undercoats 6 are formed on the resistive elements 5 respectively. Then, the resistive elements 5 covered with the undercoats 6 are irradiated with a laser beam so as to form trimming grooves 10 therein. Then, epoxy-based resin paste is screen-printed and thermally cured in the regions where the undercoats 6 and the resistive elements 5 should be covered. Thus, as shown in FIG. 5(e), overcoats 7 which extend like belts across the secondary segmentation grooves 52 are formed in the regions where the undercoats 6 and the resistive elements 5 should be covered. Here, any timing may be used as the timing for forming the segmentation grooves by the laser scribing method, as long as it is before the large substrate 50 is broken (for primary segmentation) into strip-like parts which will be described later, after the surface electrodes 3 are formed.

The steps performed so far are batch processing performed on the large substrate 50. In the next step, the large substrate 50 is broken (for primarily segmentation) into strip-like parts along the primary segmentation grooves 51 and 53 in the front and back surfaces. Thus, as shown in FIG. 5(f), a plurality of strip-like substrates 60 are obtained from the large substrate 50. The primary segmentation work is performed by bending stress which is applied in a direction to extend the front surface side of the large substrate 50. Thus, the primary segmentation grooves 51 are broken by the bending stress so that openings in the grooves on the front surface side can be opened.

Here, the groove depth of each primary segmentation groove 51 formed in the front surface of the large substrate 50 is not even but has regions with a large groove depth and regions with a small groove depth. Therefore, during the primary segmentation, the primary segmentation groove 51 first begins to break from the regions (the portions with the groove depth D2 in FIG. 6) which are small in groove depth but strong, and then breaks in the intersection portions (the portions with the groove depth D1 in FIG. 6) which are large in groove depth but brittle. Accordingly, it is possible to perform primary segmentation on the primary segmentation groove 51 without applying a large load to the intersection portions which are low in strength. Thus, it is possible to prevent chipping from occurring in the intersection portions.

Next, the strip-like substrates 60 are put on top of one another in an up/down direction. Then, Ni/Cr is sputtered all over end faces of the respective strip-like substrates 60 in this state. Thus, end face electrodes 8 which bridge the front electrodes 3 and the back electrodes 4 are formed on the end faces of the strip-like substrates 60. Then, secondary segmentation is performed to break the strip-like substrates 60 along the secondary segmentation grooves 52 and 54 in the front and back surfaces. As shown in FIG. 5(g), individual pieces (single chips) 70 each having an equivalent size to the chip-resistor 1 are obtained. Finally, electroplating is applied to an insulating substrate 2 of each individual divided single chip 70. Thus, a plating layer 9 is formed on the insulating substrate 2 so that parts of the front electrodes 3, the back electrodes 4 and the end face electrodes 8 can be covered with the plating layer 9. Thus, the chip-resistor 1 shown in FIGS. 1 and 2 is completed.

As described above, the method for manufacturing the chip-resistor 1 according to the embodiment is performed as follows. That is, the pairs of the surface electrodes 3 thick (30 μm to 60 μm) in film thickness are formed on the front surface of the large substrate 50, and the large substrate 50 is then irradiated with a laser so that the primary segmentation grooves 51 each having an uneven depth can be formed in the large substrate 50 to extend across the surface electrodes 3. Then, primary segmentation is performed on the large substrate 50 along the primary segmentation grooves 51 so as to open the surface side where the surface electrodes 3 are formed. Therefore, during the primary segmentation, each primary segmentation groove 51 begins to break from the electrode formation regions which are small in groove depth but strong, and then breaks in the intersection portions which are large in groove depth but brittle. Accordingly, it is possible to perform primary segmentation on the primary segmentation groove 51 without applying a large load to the intersection portions which are low in strength. Thus, it is possible to prevent chipping from occurring in the intersection portions. In addition, the primary segmentation groove 51 having such an uneven depth can be formed easily by the laser scribing method. Thus, it is possible to simplify the process for manufacturing the chip-resistor 1 accordingly.

### REFERENCE SIGNS LIST

1 chip-resistor
2 insulating substrate
3 surface electrode
4 back electrode
5 resistive element
6 undercoat
7 overcoat
8 end face electrode
9 plating layer
10 trimming groove
20, 50 large substrate
21, 51 primary segmentation groove
22, 52 secondary segmentation groove
30, 60 strip-like substrate
40, 70 single chip

1. A chip-resistor manufacturing method, comprising: a step of forming primary segmentation grooves and secondary segmentation grooves in a sheet-like large substrate to thereby extend the primary segmentation grooves and the secondary segmentation grooves longitudinally and laterally; a step of forming pairs of electrodes in one surface of the large substrate to thereby extend the electrodes across the primary segmentation grooves; a step of forming resistive elements to thereby connect the resistive elements to the pairs of electrodes; a step of forming a protective layer to thereby cover the resistive elements with the protective layer; a step of segmenting the large substrate along the primary segmentation grooves to thereby form strip-like substrates; a step of forming end face electrodes on segmentation faces of the strip-like substrates; and a step of segmenting the strip-like substrates along the secondary segmentation grooves to thereby form individual devices; wherein:
of the primary segmentation grooves, regions which include intersection portions with the secondary segmentation grooves and in which the electrodes are not formed are set to be larger in groove depth than regions in which the electrodes are formed, so that the large substrate can be segmented along the primary segmentation grooves to thereby form the strip-like substrates.

2. A chip-resistor manufacturing method according to claim 1, wherein: the relation D1≧(D2+20 μm) is established between D1 and D2 when the groove depth in the regions where the electrodes are not formed is D1 and the groove depth in the regions where the electrodes are formed is D2.

3. A chip-resistor manufacturing method according to claim 1, wherein: the electrodes are formed with a film thickness of 30 μm to 60 μm on the large substrate, and the large substrate is then irradiated with a laser so that the primary segmentation grooves can be formed in the large substrate to extend across the electrodes.

4. A chip-resistor manufacturing method according to claim 2, wherein: the electrodes are formed with a film thickness of 30 μm to 60 μm on the large substrate, and the large substrate is then irradiated with a laser so that the primary segmentation grooves can be formed in the large substrate to extend across the electrodes.
